(19) United States
(12) Patent Application Publication
(10) Pub. No.: US 2017/0161916 A1
(43) Pub. Date: Jun. 8, 2017

(54) HIGH PERFORMANCE AND MORE ACCURATE METHOD AND IMPLEMENTATION FOR SOLID COLOR BACKGROUND REMOVAL

(71) Applicant: Jeffrey Sun, Palo Alto, CA (US)

(72) Inventor: Jeffrey Sun, Palo Alto, CA (US)

(21) Appl. No.: 14/962,888

(22) Filed: Dec. 8, 2015

(51) Int. Cl. G06T 7/40; G06T 1/20; G06T 7/00

(52) U.S. Cl. CPC G06T 7/408; G06T 7/0079; G06T 1/20; G06T 2207/20144; G06T 2207/10024

(57) ABSTRACT

A raster image processing algorithm for the removal of solid background colors, while accurately deducing the color and opacity of border pixels of the foreground elements. Useful applications of this algorithm include removing the background from clip-art or icon images, so that these images can be used later, rendered on different backgrounds. In this algorithm, the resulting foreground's border pixels are deduced by scanning the neighboring pixels for opposing pairs of the background color and the full foreground color, and by applying a reverse alpha compositing operation. The format of this algorithm is easily run in parallel manner on the GPU, making it process medium-sized images (around 1 megapixel), in a matter of milliseconds, where it usually takes several minutes by prior art.

### FIELD OF THE INVENTION

This invention relates to the removal of solid background color from anti-aliased raster images. The present invention relates particularly to correctly deducing the border pixels of anti-aliased foreground elements, after the background is removed.

### BACKGROUND OF THE INVENTION

In image editing applications, a common operation is the automatic removal of certain areas, like the background. For solid, or near solid, backgrounds, this is usually done by fully removing pixels that fall into a certain threshold of closeness to the background color.

However, because these current algorithms that use this threshold method (U.S. Pat. No. 8,488,875 B2) either fully remove or keep every pixel, the result is that the border of the foreground elements becomes jagged. Instead, the desired behavior is to have the border pixels of the foreground elements become partially transparent (lowered opacity, the alpha channel), so that this foreground element can be smoothly rendered onto any background later.

The challenge with fixing these border pixels is that we need to deduce the original color of the border pixel. For example, if we have a solid red foreground element on a solid white background, the image will contain pink pixels around the edge of the foreground element. The goal is to remove all white pixels, and to turn all pink pixels into red pixels with reduced opacity.

An existing method that attempts to solve this issue is vectorization (US 20020006224 A1, US 2012011309 A1). In a vectorization solution, the input raster image is turned into an infinitely scalable vector image, the background is removed, and the vector foreground is rendered. However, the initial vectorization operation is excessive, taking several minutes to process a medium-sized image (1 megapixel) on an atypical device like a cellphone, and it requires many technical challenges to maintain accuracy. A simpler and more specialized algorithm in this application that does not resort to vectorization may solve the problem with more accuracy, and much more quickly (in milliseconds, rather than minutes).

### SUMMARY OF THE INVENTION

This invention presents a method of removing solid background color from raster images, in a way that correctly deduces the color and opacity of border pixels of the foreground elements. After this time-efficient background removal, the output is a smoothly anti-aliased image, consisting of the foreground elements, which is ready to be rendered on any other background.

### BRIEF DESCRIPTION OF THE DRAWINGS

FIG. 1 shows an input image, along with current and desired output images.

FIG. 2 shows the mathematics of alpha compositing and reverse alpha compositing, to be used for deducing original foreground colors.

FIG. 3 shows a 3 by 3 grid being considered within a given input image. For a given input image, the output value of every pixel is determined by scanning the input pixel and its neighbors within the 3 by 3 grid.

FIG. 4 shows a code implementation of the algorithm described in this application, written in GLSL, to be run in a fragment shader on the GPU.

### DETAILED DESCRIPTION OF THE DRAWINGS

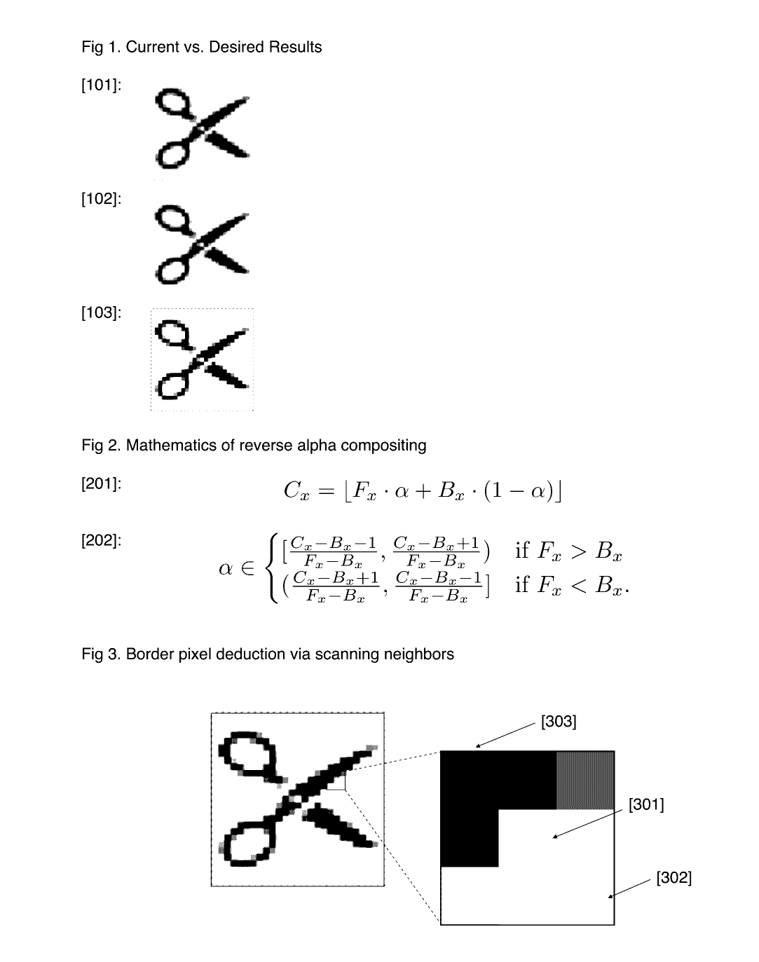

FIG. 1 shows an input raster image 101, along with the output raster image 102 from current threshold-based background removal algorithms. Raster image 103 is a desired and achievable output image, using my new alpha deduction background removal method. Notice that the desired output removes the yellow background, even around the border of the foreground element. Also, it should be noted that the white areas in the two output images [102] [103] represent completely transparent areas, with all color removed (rather than a solid white background). Additionally, the gray-looking pixels in the desired output image are not gray pixels, but rather black pixels with reduced opacity.

FIG. 2 shows the mathematics of alpha compositing. Formula 201 is the standard alpha compositing equation used in computer displays, for rendering one translucent foreground color F over a solid background color B. C is the output color of combining color F at opacity level α over color B. Each value Cx, Fx, and Bx are integers in the range 0 to 255, α is a value between 0 and 1, and x represents the channel (either red, blue, or green), since this equation calculates the resulting color C separately in the red, green, and blue channels. Formula 202 shows reverse alpha compositing, which is used by my algorithm to solve for the opacity level α, given combined color C, foreground color F, and background color B. Since Cx, Fx, and Bx have been discretized (they're integers), we can only get a feasible range for what α is. Since the color was calculated separately in the red, green, and blue channels, we will get three feasible ranges for α by applying this formula for each channel. The intersection of these three ranges is a new, smaller, and more accurate range for determining α. Finally, since we know α is a multiple of 1/255 because of the way computers represent color opacity, this formula is able to deduce the α opacity level to a very accurate range.

FIG. 3 shows a step in this algorithm, where a 3 by 3 grid of pixels in the input image are considered. To determine the color for a certain output pixel [301], my algorithm looks at the color of the input pixel at that location, as well as its 8 pixel neighbors. Thus each output pixel is determined by a 3 by 3 grid of pixels in the input image. Pixel 301 is the pixel being considered. If the pixel being considered is the same as the background color, the output at that location is a clear color, since it is removed. We know what the background color is by performing a separate and arbitrary deduction process before we run our background removal algorithm. Now along with the other neighbor pixels considered, pixel 302 is the background color, and pixel 303 is a foreground color. Using my reverse alpha compositing formula, we can deduce that our center pixel is the foreground color rendered at a certain opacity α over the background color. This constitutes our output for that pixel.

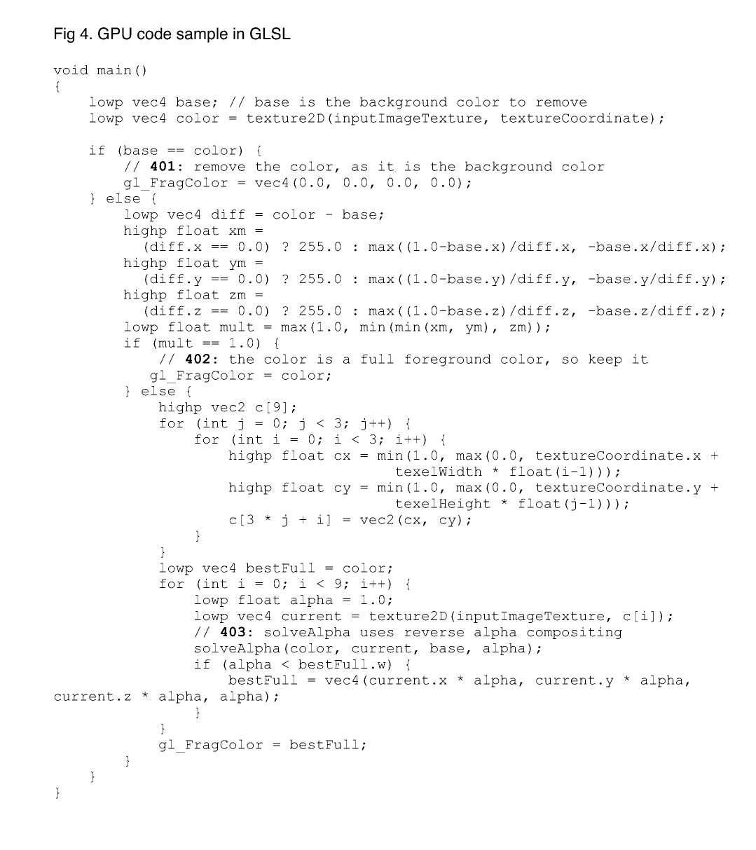

FIG. 4 shows a code implementation of my algorithm. This code body is run for every pixel in the input image, and the output pixel color is returned as gl_FragColor. In case 401, the input pixel is the background color, so our output is an empty pixel color. In case 402, the input pixel color cannot have been a translucent color rendered on top of the background color, so it is left untouched. In case 403, we perform a call to a function called solveAlpha, which uses our reverse alpha compositing formula to determine the feasible α opacity value of our input pixel if it had been a neighboring foreground color rendered on top of an opposite-side neighboring background color. If the solution for α is infeasible, solveAlpha will do nothing. If it is feasible, then the candidate for the output color is a color with the same red, green, and blue components as the neighboring foreground color, but with an opacity level of α.

What is claimed is:

1. A method comprising:
A more accurate and faster method for raster input and background-removed output images of flat colors (not necessarily opaque), with anti-aliased foreground elements.

2. The method of claim 1 further comprising:
Deduction of opacity level of rendered colors, based on the original foreground and background colors.
